(19) United States
(12) Patent Application Publication
(10) Pub. No.: US 2012/0020847 A1
(43) Pub. Date: Jan. 26, 2012

(54) Retention Of Solid Powder Catalyst By In-Situ Cross Flow Filtration In Continuous Stirred Reactors

(75) Inventor: William Raymond Jones, Bartlett, TN (US)

(73) Assignee: Lurgi, Inc., Memphis, TN (US)

(21) Appl. No.: 12/898,892

(22) Filed: Oct. 6, 2010

Related U.S. Application Data
(60) Provisional application No. 61/365,989, filed on Jul. 20, 2010.

(51) Int. Cl. B01J 19/00

(52) U.S. Cl. 422/224

(57) ABSTRACT

A system for the retention of finely divided solid catalysts inside a continuously stirred back-mixed reactor is presented. The system includes multiple porous media filter elements and multiple reactor baffles. The porous media filter elements are located to act as part of said reactor baffles. The porous media is selected to retain the large majority of the catalyst particles while allowing the reacted contents to leave the reactor through the pores of the porous media. The porous media elements may have a circular cross-section. The system utilizes the pumped flow of the reactor's agitator system to sweep solids from the porous media, and a high velocity zone is created around the back side of the porous media filter elements by a venturi effect caused by design and placement of the baffles and the porous media elements.

### CROSS-REFERENCE TO RELATED APPLICATIONS

This application claims the benefit of U.S. Provisional Application No. 61/365,989, filed Jul. 20, 2010, the entire contents of which are incorporated herein by reference.

### BACKGROUND

This invention relates to the use of finely divided heterogeneous solid particle catalysts inside continuously stirred back mixed reactors, and more specifically to the retention of those catalyst particles inside the reactor while allowing continuous flow of liquid feed and reactant materials into the reactor, and reaction products to flow out of the reactor while preventing catalyst to exit the reactor with the reactant flow. More specifically, the invention allows the just described process to occur while maintaining a clean catalyst retention media via dynamic cross flow filtration caused by the velocity of liquid reactants across the retention media generated by the agitator device inside the reactor. Heterogeneous solid catalysts have been used for conversion of many chemicals and generally in two forms. Catalysts are either larger structured forms for fixed beds or finely divided powder form for fluidized reaction applications.

A fixed bed of catalyst has been used with liquid or gaseous reactants flowing across and through the catalyst bed causing the desired catalyzed reaction conversion to take place. Alternatively, finely divided solid catalysts have also been used in fluidized beds wherein the catalyst is recirculated from the reactor top to the reactor bottom or side, and separated either by cyclonic devices or by filtration devices or retention screens.

Powdered solid catalysts are seldom or infrequently used in vertical continuously stirred back-mix reactors in continuous feed applications, principally because of the challenges with catalyst retention or with catalyst exit with the reaction products and subsequent recovery and replenishment. With this system of a reactor and external catalyst filter, it is difficult to maintain a constant uniform concentration of catalyst inside the reactor. Alternatively internal catalyst retention devices are frequently plugged by the filtered catalyst causing the loss of flow of reactants from the reactor.

In some instances, this has been attempted using an external filter to collect the catalyst using a very high pumped flow rate to cause “cross flow” filtration which is filtration allowing the liquid to pass through the filter but with high enough velocity that solids are swept immediately from the filtration media as they build up. The high velocity stream requires substantial extra energy to create the flow and required velocity to create the “cross flow” conditions.

In other cases, multi-chambered filters are used, allowing catalyst to be reclaimed in one or more filter chambers, while other chambers are “cleaned” whereby the catalyst “cleaned” from the filter is recycled back and recharged into the reactor. This is a cumbersome system causing cyclic shortages and surpluses of catalyst in the reactor.

This invention seeks to solve this problem by means of continuous “cross flow” filtration of the powdered solid catalyst in situ inside the reactor, allowing the maintenance of a constant catalyst concentration inside the reactor and a relatively small catalyst make up requirement for attrition and loss of catalyst fines.

### SUMMARY

A system for the retention of finely divided solid catalysts inside a continuously stirred back-mixed reactor is presented. The system includes multiple porous media filter elements and multiple reactor baffles. The porous media filter elements are located to act as part of said reactor baffles. The porous media is selected to retain the large majority of the catalyst particles while allowing the reacted contents to leave the reactor through the pores of the porous media. The porous media elements may have a circular cross-section.

### BRIEF DESCRIPTION OF THE FIGURES

FIG. 1 illustrates a configuration with straight angled baffles, in accordance with one embodiment of the present invention.

FIG. 2 illustrates a configuration with curved angled baffles, in accordance with one embodiment of the present invention.

FIG. 3 illustrates a typical internal flow pattern, in accordance with one embodiment of the present invention.

FIG. 4 illustrates a basic layout of the reactor internals, in accordance with one embodiment of the present invention.

FIG. 5 illustrates a cross-sectional view of a porous media filter element, in accordance with one embodiment of the present invention.

FIG. 6 illustrates a typical reactor with porous media elements, baffles not shown, in accordance with one embodiment of the present invention.

FIG. 7 illustrates a cross-sectional view of a porous media filter element, indicating the external ring header, in accordance with one embodiment of the present invention.

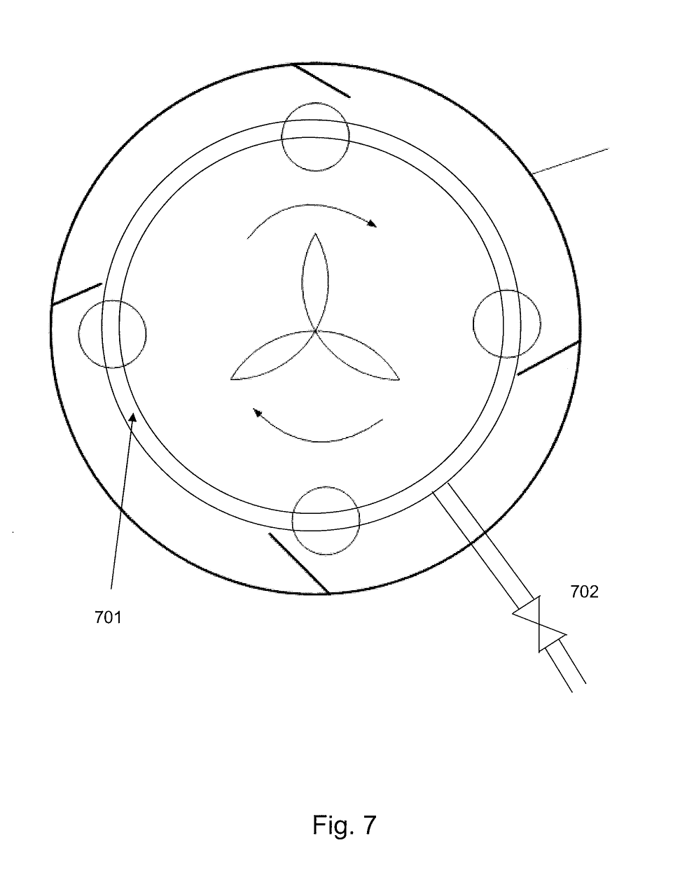

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

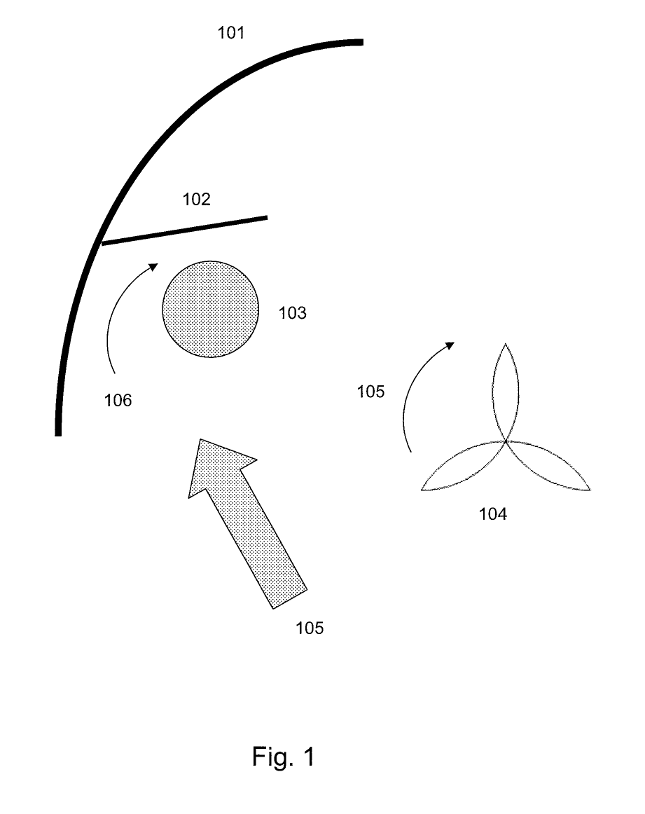

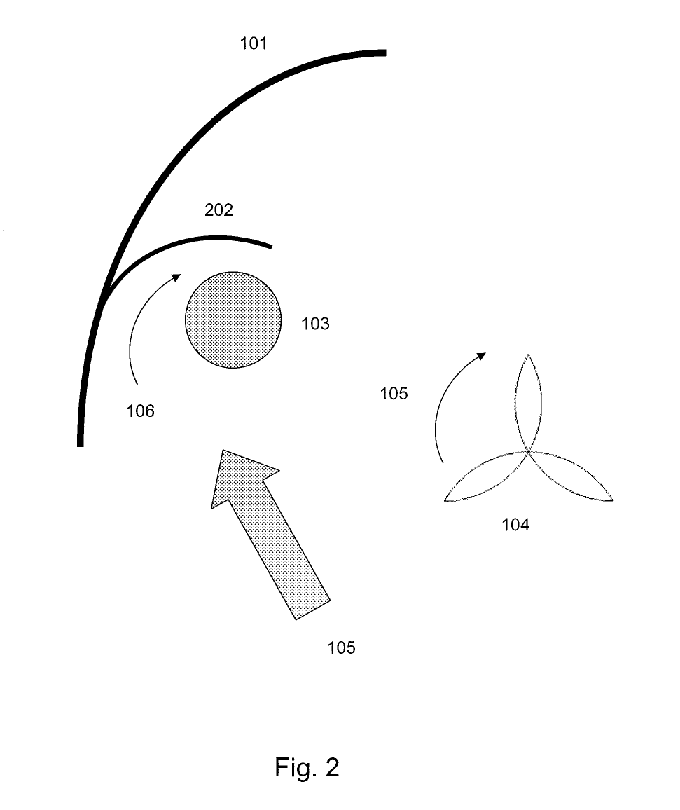

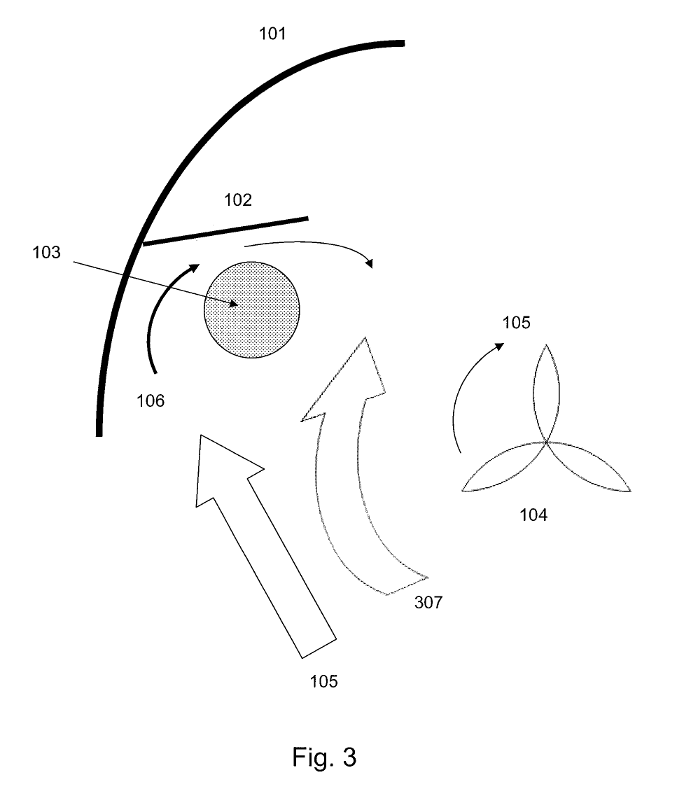

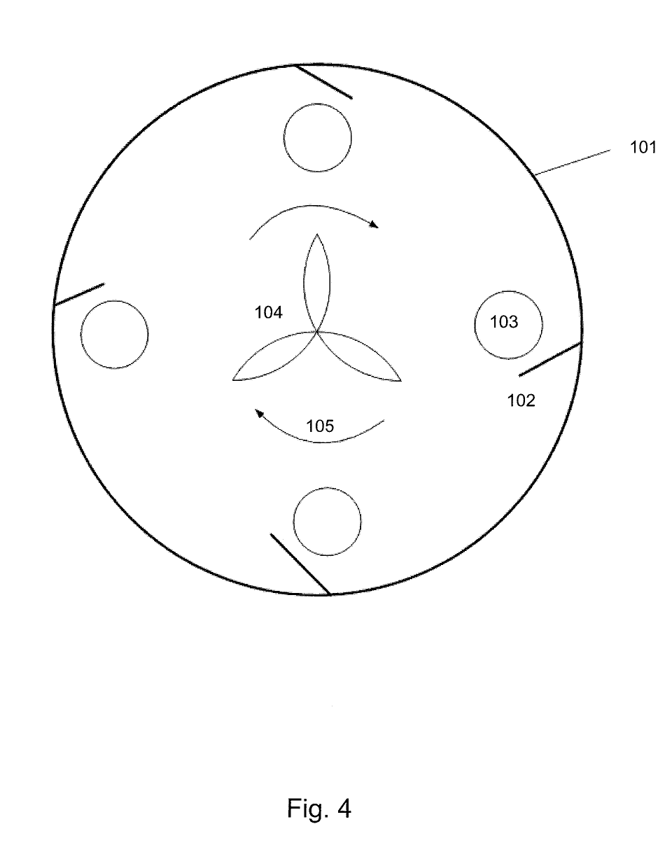

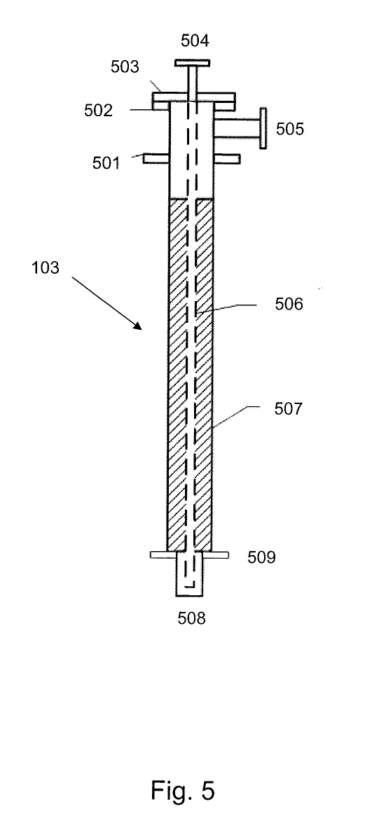

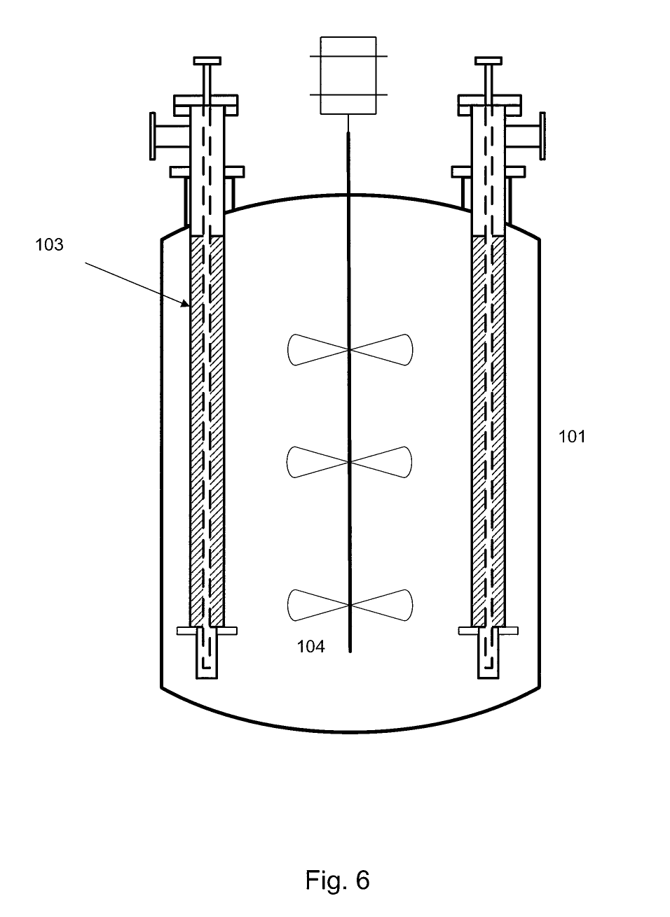

The concept of this invention is to retain the finely divided solid catalyst inside a continuous stirred reactor system, while allowing continuous inflow of new reactants, and outflow of reaction products. As illustrated in FIGS. 1 through 6, this is accomplished by the installation of integral porous media filtering elements 103 into the reactor 101 in such a way that these porous media elements 103 act as part of the baffles of the stirred reactor. In addition angled baffles 102 are installed immediately adjacent to and behind the porous media elements 103 so as to create a high velocity flow zone around and behind the porous media element. The porous filter element 103 is placed so as to form a venturi 105 between the curved surface of the filter element and the angled 102 or curved 202 baffle a short distance away.

In addition a high velocity flow pattern 106 is created across and around the porous media filtering element 103 which immediately and continuously “sweep” any incident accumulation of “filtered” catalyst particles from the surface of the porous media element 103. The leading surface of the porous media element is swept directly by the encountered turbulent flow 307 from the agitator 105. The protected backside surface of the porous media element is swept by a high velocity and turbulent stream 106 created by the venturi effect of the space between the porous media element 103 and the angled 102 or curved baffle 202.

Such filtration action is commonly referred to as “cross flow” filtration. In this case, instead of a high volume pumped flow to a separate cross flow filter unit, the high cross flow velocity is created by the pumping action of the agitator system 104 inside the reactor. A number of porous media filter element 103 and associated baffles 102, 202 are installed to produce the desired flow rate of liquid reaction products from the reactor, and are placed at strategic locations to act as baffles for the reactor.

A further feature of this invention is that inside the porous media filter element or elements have a “dip tube” 506 that proceeds from the external top of the reactor down to near the very bottom of the porous media element 103. This dip tube 506 provides a liquid seal inside the porous media element 103 and conducts the filtered reaction product up and out of each porous media element 103 and hence from the reactor to a header that collects the flow from all porous elements.

And further the active porous surface 507 of the porous media element 103 is constructed and configured so that the porous surface 507 will always be below the liquid level surface of the contents of the reactor. This is done to prevent the out flow of the gases or vapors in the vapor space portion of the reactor, and to thereby preferentially cause only reacted liquid contents to flow through the porous element and out of the reactor.

Any very fine solids that “slip through” the porous elements and exit with the reactor products can be more easily filtered out, and periodically a small solid catalyst addition can be made to make up for such catalyst attrition.

By avoiding an external “cross flow” filtration unit, this invention saves not only additional capital cost of that equipment, but also the energy cost for pumping the high volumetric flow rates required for such cross flow filtration as well.

Finely divided active catalyst particles are retained inside the reactor and swept from the surface of the porous filter media by the high velocity of fluid flowing past the media, said flow created by the hydraulic action of the agitator inside the reactor and the design of the placement of the porous media elements with respect to the angled or curved baffles of the reactor.

The invention will be applicable to most any continuously stirred back mix reactor system of liquid reaction contents requiring a finely divided solid catalyst to be involved inside the reactor whereby it is desired that the catalyst be retained inside the reactor for continuous feed of reaction ingredients and continuous extraction of reaction products.

In one embodiment of the present invention, a system for retention of finely divided solid catalysts inside a continuously stirred back-mixed reactor is provided. The invention comprises multiple porous media filter elements 103 and multiple reactor baffles 102, 202, where the porous media filter elements 103 are located to act as part of said reactor baffles 102, 202. The porous media 103 may be selected to retain the large majority of the catalyst particles while allowing the reacted contents to leave the reactor through the pores of the porous media.

In one embodiment, the porous media elements may have a circular cross-section. The porous media elements may be constructed of any material that is compatible with the reaction mix contents and ingredients inside the reactor; and of sufficient strength to withstand the forces of agitation inside the reactor. The material may be selected from the group consisting of metal, ceramic, plastic, and natural materials.

In one embodiment, the porous media element 103 may be located adjacent to an angled baffle 102, 202 of the reactor, the baffle being angled to allow flow 106 of reactor contents caused by the agitation of the reactor 104 to pass between the porous media element 103 and the angled baffle 102, 202. The placement of the porous media 103 with respect to the angled baffle 102, 202 may be designed to cause a venturi between the baffle 102, 202 and the porous media surface 103, where the porous media 103 has a circular cross-section.

In one embodiment, the venturi may cause an increase in fluid velocity between the baffle 102, 202 and the porous media surface 103, thereby sweeping the finely divided solid catalyst from the porous media surface 507 due to hydraulic velocity and turbulence. The angled baffles may be straight 102 or curved 202.

The porous media element may comprise an internal dip tube 506. In one embodiment, the porous media element 103 has a circular cross-section, and the internal dip tube 506 is concentric with said porous media element 103. The dip tube 506 may have an open end, where the open end of the dip tube 506 is located near the bottom of the porous element, thereby causing any solid material trapped inside the element to be “vacuumed” into the liquid leaving via the dip tube, thus cleaning the inside of the porous element of solid build up.

The dip tube 506 may serve to seal any gaseous material inside the reactor by allowing only liquid that has passed through the porous media 103 to leave via the open end of the dip tube. The porous element 103 may comprise a sump 508 at the bottom, and wherein the dip tube 506 is further recessed into said sump 508 to better facilitate the removal of solid particles that pass through said porous media. The porous filter elements 103 are locked securely in place by a locking device 502 at the bottom and at the top of the element to avoid vibration and to withstand the forces of agitation inside the reactor.

The locking device 502 may be a flanged connection, a clamped connection, or a threaded connection. The locking device 502 may be any form of mechanical restraint sufficient for the purpose of fastening the bottom of the porous element in place against the forces of agitation.

In one embodiment, the porous element 103 comprises a mounting flange to reactor vessel 501, a top flange 502, a dip tube mounting flange 503, a dip tube flange 504, a back flush connection 505, a dip tube 506, a porous media surface 507, a dip tube sump 508, and a bottom mounting flange 509.

The number, diameter, and length of said porous elements 103 are designed to provide the required filtration surface for effective filtration of catalyst and to allow adequate flow of material through the reactor continuously for the production required from said reactor. The porous elements are connected via an external ring header 701 or common header to allow for control of flow through the porous element system to be controlled by one or more control valves 702 external and connected to the header.

The porous media elements 103 may be secured at the top of the reactor by flanged connections 504 to the reactor. The flanged connection 504 for each porous media element 103 at the top of the reactor features a connection 505 for back-flush cleaning of the porous media element 103. The size of the back-flush connection 505 is determined by the parameters of the porous media's back-flush requirement, and the pressures of operation of the reactor, and the characteristics of the back-flush media.

The internal pressure of the reactor is maintained so as to be the driving force for flow of reactor contents through the porous media. The maintenance of internal reactor pressure may be by any external means consistent with the reactor system and the safety requirements of the reactor, its surroundings and the ingredients of the reaction.

What is claimed is:

1. A system for retention of finely divided solid catalysts inside a continuously stirred back-mixed reactor, comprising multiple porous media filter elements and multiple reactor baffles, wherein said porous media filter elements are located to act as part of said reactor baffles.

2. The system of claim 1, wherein said porous media is selected to retain the large majority of the catalyst particles while allowing the reacted contents to leave the reactor through the pores of the porous media.

3. The system of claim 1, wherein said porous media elements have a circular cross-section

4. The system of claim 1, wherein said porous media elements have an elliptical cross section.

5. The system of claim 1, wherein the porous media elements may be constructed of any material that is compatible with the reaction mix contents and ingredients inside the reactor; and of sufficient strength to withstand the forces of agitation inside the reactor.

6. The system of claim 5, wherein said material is selected from the group consisting of metal, ceramic, plastic, and natural materials.

7. The system of claim 1, wherein said porous media element is located adjacent to an angled baffle of the reactor, said baffle angled to allow flow of reactor contents caused by the agitation of the reactor to pass between the porous media element and the angled baffle.

8. The system of claim 7, wherein the placement of the porous media with respect to the angled baffle causes venturi between said baffle and said porous media surface, wherein said porous media has a circular cross-section.

9. The system of claim 8, wherein said venturi causes an increase in fluid velocity between said baffle and said porous media surface, thereby sweeping said finely divided solid catalyst from the porous media surface due to hydraulic velocity and turbulence.

10. The system of claim 9, wherein said angled baffle is straight.

11. The system of claim 9, wherein said angled baffle is curved.

12. The system of claim 1, wherein said porous media element comprises an internal dip tube.

13. The system of claim 12, wherein said porous media element has a circular cross-section, and wherein said internal dip tube is concentric with said porous media element.

14. The system of claim 12, wherein the dip tube has an open end, wherein the open end of the dip tube is located near the bottom of the porous element, thereby causing any solid material trapped inside the element to be “vacuumed” into the liquid leaving via the dip tube, thus cleaning the inside of the porous element of solid build up.

15. The system of claim 12, wherein the dip tube serves to seal any gaseous material inside the reactor by allowing only liquid that has passed through the porous media to leave via the open end of the dip tube.

16. The system of claim 12, wherein the porous element comprises a sump at the bottom, and wherein the dip tube is further recessed into said sump to better facilitate the removal of solid particles that pass through said porous media.

17. The system of claim 1, wherein said porous filter elements are locked securely in place at the bottom and at the top of the element to avoid vibration and to withstand the forces of agitation inside the reactor.

18. The system of claim 17, wherein said locking device may be a flanged connection, a clamped connection, or a threaded connection.

19. The system of claim 17, wherein said locking device may be any form of mechanical restraint sufficient for the purpose of fastening the bottom of the porous element in place against the forces of agitation.

20. The system of claim 1, wherein the number, diameter, and length of said porous elements are designed to provide the required filtration surface for effective filtration of catalyst and to allow adequate flow of material through the reactor continuously for the production required from said reactor.

21. The system of claim 1, wherein said porous elements are connected via an external ring header or common header to allow for control of flow through the porous element system to be controlled by one or more control valves external and connected to the header.

22. The system of claim 1, wherein said porous media elements are secured at the top of the reactor by flanged connections to the reactor.

23. The system of claim 22, wherein said flanged connection for each porous media element at the top of the reactor features a connection for back-flush cleaning of the porous media element.

24. The system of claim 23, wherein size of the back-flush connection is determined by the parameters of the porous media's back-flush requirement, and the pressures of operation of the reactor, and the characteristics of the back-flush media.

25. The system of claim 1, wherein the internal pressure of the reactor is maintained so as to be the driving force for flow of reactor contents through the porous media.

26. The system of claim 25, wherein the maintenance of internal reactor pressure may be by any external means consistent with the reactor system and the safety requirements of the reactor, its surroundings and the ingredients of the reaction.
